(19) United States
(12) Patent Application Publication
(10) Pub. No.: US 2004/0220854 A1
(43) Pub. Date: Nov. 4, 2004

(54) System and method for generating destination specific coupons for a traveler

(76) Inventor: Richard Postrel, Miami Beach, FL (US)

Correspondence Address: ANTHONY R BARKUME, 20 GATEWAY LANE, MANORVILLE, NY, 11949, US

(21) Appl. No.: 10/699,101

(22) Filed: Oct. 30, 2003

Related U.S. Application Data
(63) Continuation of application No. 09/658,329, filed on Sep. 8, 2000, now abandoned.
(60) Provisional application No. 60/153,353, filed on Sep. 10, 1999.

(51) Int. Cl. G06F 17/60

(52) U.S. Cl. 705/14

(57) ABSTRACT

A travel coupon server system and method generate travel coupons, and include a plurality of members and a travel coupon server which is interconnected to the plurality of members. The travel coupon server generates limited duration coupons for a particular traveler which identifies the traveler by name, which limits the duration of the offer of the coupon to the time of the travel, and which limits the coupons offered to the traveler's destinations or along the route to those destinations.

### CROSS-REFERENCE TO RELATED APPLICATIONS

This application is based on and claims filing priority of co-pending U.S. provisional patent application serial No. 60/153,353, filed on Sep. 10, 1999.

### BACKGROUND OF THE INVENTION

The present invention relates to systems that allow coupon providers to generate packages of offers or coupons to travelers where the traveler specifies personal information regarding travel preferences, purpose of travel, destination information and time frame for travel and the system generates a personalized collection of limited time offer valued coupons or certificates where the offer is valid only during the prearranged time of travel.

Coupon offers typically have very low levels of response when a generalized distribution media is used such as via newspaper insert, supermarket flyer or other printed certificate based offers. These types of offers generally provide little incentive for the traveler to take advantage of the offer.

Travelers on the other hand typically have a very specific purpose in mind when traveling to a destination. While knowing what they would like to do at these destinations, these travelers typically know little of the available offerings of that destination other than that which is supplied by a travel agent or a hotel concierge, or other sale/service commission agents. In order to facilitate the planning process, travel agents typically provide information to travelers based on what they know about the destination or what promotional material has been supplied to the agent by chambers of commerce, hotels, cruise lines, etc.

What is desired therefore, is a system to supply specific coupon content to the traveler directly or through an intermediary such as a travel agent, airline or transportation provider to increase the likelihood of the traveler accepting the offer and acting on or exercising the offer.

What is also desired is that the coupons provided are valid during the period of time that the traveler is at that destination, and that the coupons are dedicated and specifically usable by the traveler when they are at that location.

### SUMMARY OF THE INVENTION

A system and method are described in an E-commerce application for generating limited duration coupons for a particular traveler that identifies the traveler by name, limits the duration of the offer to the time of the travel, and limits the coupons offered to the traveler's destinations or along the route to those destinations. The purpose of the travel (business, leisure, combination) is used as one of the parameters to find the offers that best match the traveler preferences and parameters. Other parameters used may be the time of year, the duration of the travel, the season of travel, etc. The system and method may also be applied to geographic areas regardless of whether or not the coupon redeemer is traveling, and so coupons may be provided to local or domestic points of interest, shops, services, and the like and not limited to long distance excursions.

### BRIEF DESCRIPTION OF THE DRAWINGS

FIG. 1 is representative of the traveler coupon system and members of the present invention;

FIG. 2 is a data flow diagram of the travel definition process of the present invention;

FIG. 3 is a data flow diagram of the offer generation process and the coupon generation process of the present invention.

### DETAILED DESCRIPTION OF THE PREFERRED EMBODIMENT

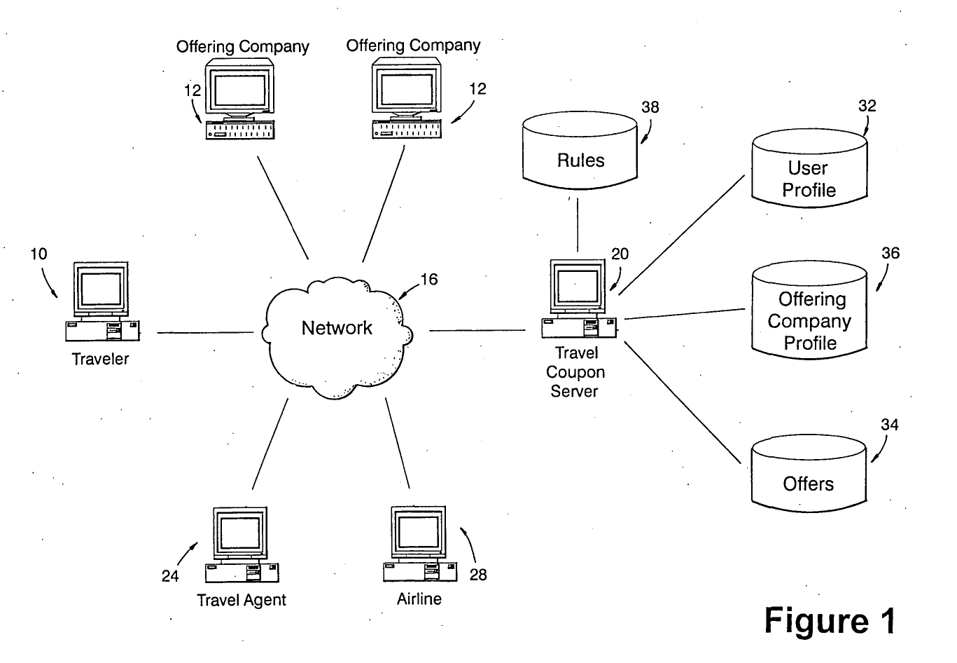

The system and method of the present invention (see FIG. 1) comprise a travel coupon server 20, interconnected through a network 16, such as the Internet, to a plurality of members, such as service subscribers or participants, comprising a plurality of coupon offering companies 12 and a plurality of travelers 10, and optionally may include a plurality of intermediary agents, where the intermediary agents may be representative of travel agents 24 or airlines 28, cruise lines or other travel information providers. The travel coupon server 20 comprises: processor means for managing the data of the system and generating content for the participating members of the system, database means for storing profile data, offer data and rules of the system, and access means for receiving and interpreting input from the participating members of the system.

The database means preferably comprises means for storing user/traveler profile data 32, offer data 34, offering company profile data 36 and rules 38. Users can request services or coupons, and the system maintains a bulletin board of such user requests to be accessed by companies to prompt the generation of offers to address such unfulfilled needs or desires of users. Alternatively, the system may forward to companies or process such requests with companies to prompt offer generation by the companies.

The term “coupon” will be used generically to represent any type of offer, certificate, or voucher that may be acted upon by a member of the system, and the term “server” will generically refer to any person, company or computing process capable of recording and compiling information which is geographically dedicated or targeted, and which may also involve travel. In the preferred embodiment, the coupon offering companies 12 provide parameters of an offer to the travel coupon server 20 of the present invention. These offers may be numerically limited to a predetermined number of coupons available to be redeemed, and such offers may be seasonal or time limited offers where the offer may be specifically or universally targeted at a traveler community or membership-based groups. The discounts of the coupons need not be static; for example, the discounts may be scaled such that groups of users have either decreasing or increased discount values; for example, earlier users of the coupons may receive greater discounts than later users.

The offers will typically have some redeemable value to the traveler 10 and will typically involve redemption at the travel destination or a point on the itinerary of the traveler 10. The coupon user such as a traveler may view such offers via a computer, for example, using a browser accessing a web page of the offering company 12 or a subscribing network of coupon providers, which displays a counter of the number of coupons used and/or available, and so the coupon user may be able to learn how many of such coupons can be used or are available. Also, users may reserve coupons that may become available at a later date, such as after an initial issuance of coupons has ended, and a new issuance has occurred. The reserving user may be put on a queue and/or receives a rain check or other notifications when the coupons become available.

The offering company 12 may optionally provide profile information that is used by the processor of the travel coupon server 20 to identify travelers 10 matching a company specified profile.

Travelers 10 have at their disposal means, such as a personal computer or other known computing devices, for providing information to the travel coupon server 20 about travel related destinations that the traveler 10 wishes to schedule or to investigate. The traveler 10 may specify a general or specific timeframe of travel where this information is recorded in the database of user profiles 32. Travelers 10 have the option to enter specific itinerary information of their travel or needs and desires, to allow the system to perform more detailed analysis of compatible offers. For example, a traveler 10 may specify personal profile information, travel purpose, travel destination and length of stay, transportation accessibility and other parameters of the travel, such as special needs or particular requests for services.

Optionally travelers 10 may additionally specify information related to their businesses, with such information to be used by the travel coupon server 20 primarily if their travel is business related, where the system determines compatible or interrelated lines of business that have offers 34 stored in an offer database that may be supplied to the traveler 10 where the traveler 10 may be able to investigate potentially beneficial business relationships, as well as available or needed services such as secretarial assistance, fax or email capabilities, clothing and/or dry cleaning, health spas, gyms, masseuses, etc.

Additionally, based on the specified information about a user, such as a traveler, and/or about their businesses, the travel coupon server 20 may also push additional information to targeted users, with such additional information being related to the specified information about the user.

The system may additionally provide certificates or schedule meeting times or provide access to events that might correspond to business or personal interests. The traveler 10 may specify the amount of available time that the traveler 10 expects to be unoccupied, where a more closely generated schedule or collection of offers 34 may be prepared specifically to that traveler 10.

In another embodiment, the system may use the business profile information to determine potential training, learning or commerce opportunities that may have beneficial tax savings ramifications that cause part of the travel to be underwritten or redeemable via a taxing authority. For example, depending on the current laws of the traveler's country, the server 20 may look at the leisure travel destination to determine if other business related events may be incorporated into their available time during the trip. The relevant laws and regulations may be stored in the database of rules 38 where the rules 38 are compared to offers 34 stored in the system to determine potentially tax saving opportunities. The traveler 10 may then determine whether these events may in part be used to justify a trip to that destination.

In various embodiments, the user or traveler 10 either receives coupons by mail or downloads coupon data at a computer associated with the user. Such downloaded coupon data may then be printed by the user for immediate use. The offering company 12 and/or the administrators of the system may provide software to the user, via diskette by mail or via downloading to the user's computer, such that the installed software can process such coupon data and print the coupons, for example, with a bar code for ease of use and/or for security. In one embodiment using bar codes imprinted on the coupons, when a user redeems the coupon at a redemption station, the bar code to implement the discount, and optionally to verify that the bar code is valid to avoid fraudulent coupons being honored.

The system is thus capable of being accessed and utilized in real-time to generate coupons, for example, at the computer of the user, and also to process and honor discount coupons at the points of redemption of such coupons, such as stores, hotels, gift shops, services, etc. In addition, valid coupons may have their terms updated, for example, the issuers may change the amount of discount; the duration of use of the coupons; the types of services or products provided, due to changes of availability, etc.

For example, if a large number of coupons has not be redeemed, the offering company 12 may unilaterally extend the expiration of the coupons without requiring re-issuance of the coupons. As a bar code or other indicia such as a serial number is read or scanned from a coupon being redeemed, software at the redemption station may override the original amount of discount to be higher, or may override the original expiration date and set a later date for expiration. Accordingly, a traveler 10 having an expired coupon for a discounted hotel room may be provided the discount regardless if, for example, the offering company determines that the hotel is underbooked, or alternatively if too few of the coupons have been redeemed. In this manner, by honoring the expired coupon by resetting its expiration, offering companies 12 may encourage additional use of such discount coupons by users in the future. Such updating of coupon values or services may be performed in near or virtual real-time, for example, at the time of redemption of the coupon using redemption stations interconnected to the offering companies 12.

It is to be understood that such flexibility in adjusting the values, products, and/or services provided in conjunction with discount coupons is advantageous both to users/travelers redeeming such coupons, and to the issuers or offering companies 12 providing the offers or coupons for such values, products, or services. Besides encouraging users to access and obtain such values, products, and services, coupon issuers may more readily track new promotions for effectiveness, for changing offers frequently and/or to any chosen degree, and to manage the values offers, for example, to maintain a profit.

Examples of such improved tracking and management include the ability to offer discounts to travelers or other users for only a specific date, or for limiting the discounts to be redeemable between certain hours of a day.

The system may operate in several different manners where the user profile 32, leisure and business information is reviewed against currently existing offers 34 to determine the best coupons to be offered to the traveler 10. These offers 34 may be redeemable prior to, or on route, or throughout the travel period. The system will determine the best match of these items and generate a personalized destination package or book of those offers 34 that most closely match the profile for that traveler 10. If for instance, the traveler 10 is traveling to Orlando, Fla. for leisure, the traveler 10 specifies the times during the travel when the traveler 10 would be available for business activities, and the system may pull the offers 34 that exist in memory of the system to inform the traveler 10 of interesting business opportunities that match that timeframe and business profile specified by the traveler 10.

The system may optionally identify non-business offers in the same general time frame, or in the alternative an appropriate time frame. The system may determine from the traveler's profile 32 the type of transportation available to the traveler 10 to further limit or expand the available travel offers 34.

In another embodiment, in response to the traveler's input of travel parameters, the offering company 12 may be able to access all, or restricted portions of, the traveler's profile 32 and travel information (if permitted by the traveler's preference information) to generate new offer data 34 that may be included in the coupon package for that traveler 10. If the information is business related and geared toward the traveler's current line of business, it is to the benefit of the traveler 10 to take advantage of those events that meet the traveler's tax deductible traveling objectives, such that a portion of the travel may be dedicated to business purposes.

In this manner, the offer provides a benefit for the traveler 10 while at that destination, such that they are provided with a package of offers specifically tailored to their interests and matching their available time. The offering company 12 benefits because they have targeted an offer to those really interested in their goods or services, therefore significantly increasing the potential for commerce.

In a further embodiment, the travel coupon server 20 may be a web server capable of displaying available offers on websites accessible by travelers 10 through their computers connected to the server 20 through the Internet as the network 16. In this manner, the travel coupon server system provides an Internet-based E-commerce functionality. For example, a particular traveler 10 may access the website, and offers are then displayed on the traveler's web browser.

Alternatively or in addition, the traveler 10 may be presented with an input box or window to specify the destination of the traveler 10. In other embodiments, additional information may be provided such as tables of carriers such as airlines and their flight numbers according to destination, including connections. In response to the travel destination and/or flight numbers input by the traveler 10, the travel coupon server 20 displays to the particular traveler all available offers for such destinations or flight numbers from offering companies.

Through the web browser, the traveler 10 may then select a specific displayed offer to be printed at a printer of the traveler 10 connected to the traveler's computer, with the printed offer serving as the coupon.

In another embodiment, when the traveler 10 has selected a displayed offer, for example, by clicking a computer mouse or otherwise activating a command through a keyboard or other input device, the travel coupon server 20 responds by generating a coupon displayed on the traveler's browser to be printed out by the traveler 10. Alternatively, the travel coupon server 20 may send the generated coupon directly to the traveler's printer. The coupon may differ from the displayed order information in that the printed coupon may be in a specific coupon format, such as to be in a size and shape, with additional information printed thereon, for insertion into a passport or into a ticket envelope.

In the preferred embodiment, in order to maintain the traveler's privacy, the offering companies 12 that generate and supply the offers 34 to the system would not be provided personal information of the traveler 10 such as the traveler's name, address, company name or other personal data (unless authorized by the system or traveler 10). The offering companies 12 would be able to access generic data about the traveler 10, the type of business, and any title information and areas of interest that the traveler 10 has. This profile information may be provided for each user individually or as a compilation of travelers 10 with similar interests traveling to that destination during that time period. The offering companies 12 may use this information to generate or create an event that may be specifically adapted to the traveler's availability and interests, which may be time delineated or which may be open-ended, thereby increasing the likelihood of the traveler 10 taking advantage of the offer. The travel coupon server 20 would then receive this new offer from the offering company 12 along with the target user/traveler profiles 32 that should receive the offer. The offer 34 is stored in the offer database with a limited number of offers and a specific timeframe for the offer 34.

The travel coupon server 20 would then combine the offer 34 with the detailed traveler information to generate a customized and personalized offer for those targeted profiles selected by the offering company 12. This generated personalized offer would list the name of the traveler 10, the timeframe and times of availability, and an offer, and may optionally contain means, such as a return postcard and/or any form of E-commerce confirmation such as an E-mail confirmation message or confirmation web pages received at the user's browser over the Internet, for the traveler 10 to confirm attendance or acceptance of the offer prior to travel or during travel. Alternatively, the offer may be opened to generalized access by the travelers 10 using the system. If travelers 10 indicate that they would like to include this event in their itinerary, the offering company 12 may be informed of this by the travel coupon server 20.

Such offers need not be limited to travel opportunities; for example, regardless of whether or not the coupon redeemer is traveling, such redeemers may be enrolled in special opportunities, such as free entry into a sweepstakes or other value-added opportunities such as frequent flyer miles or points in a frequent flyer program.

The offering company 12 may specify, in a database of offering company profiles 36, the types of travelers 10 that the travel coupon server 20 should inform them about to more specifically generate targeted offer data 34. For example, a company that creates television programming for children using a studio audience may provide an offer for a reduced cost or free admission to any parents with children to attend and even participate in the filming of a popular children's televisions show. The travelers 10 may in turn contact the offering company 12 to query the offering company 12 on more detailed information prior to the travel to that destination. A communication method may be'supported by the travel coupon'server 20 to allow the traveler 10 and offering company 12 to correspond using email, phone messaging systems or other facilities that are either managed through the travel coupon server 20 or where the user may communicate directly with the offering company 12.

The coupon package would be organized and/or sorted in a prioritized manner according to the traveler's profile categories stored in the database of user profiles 32. This might cause the business related events to be toward the front of the coupon package, followed by the leisure and interest related activities. Other sorting options may be employed where all coupons would be ordered in a schedule or calendar-like form where activities occurring at the same time and day would be grouped together. In addition, sorting may be performed according to the age, gender, or other preferences which the user may have to describe the events, such as children-oriented events sorted and determined by age with such events being conducted, for example, on a cruise ship which the traveler 10 may travel on with the traveler's children.

A proposed itinerary may be included which could organize the events to best fit priorities that were specified in the database of user profiles 38, where the priorities may refer to the traveler's preference of activities. For example, a traveler 10 going to Bermuda might rate golf higher than sailing or a business meeting scheduled for the same timeframe. Other-coupon organization methods may be based on proximity to other events. A breakfast location coupon may be placed on the same coupon page as a nearby golf course coupon. Combination offers may also be generated where if you stay at a hotel, you get a rebate on a dinner cruise.

In the preferred embodiment, the system prepares and issues discount coupons for offers via a computer-based network such as the Internet. In alternative embodiment, the system may be implemented using known communication system such as telephones, facsimile machines, U.S. Postal Service and/or other courier delivery services, including wireless and/or web-based appliances, etc. The offers 34 are compiled by the travel coupon server 20 and are prepared for delivery to the traveler 10 at any fixed location of the traveler 10 such as the traveler's residence or even en route during any point of a traveler's itinerary. Thus, the system provides channel parity for all users, using any form of technology to convey to the coupon server each user's geographic location and/or changing locations on a travel itinerary.

Preferably the coupons are received and/or reviewed by the traveler 10 prior to travel, giving the traveler 10 time to review the offers 34 made. The offers 34 may be delivered to the traveler 10 using any known means for delivery such as U.S. mail delivery or delivery using preferred delivery carriers where time dependent or special handling is required. The type of delivery may also be dependent of the offers selected where an offer supplier may specify that the travelers 10 that receive the offer from that offering company 12 receive the offer separately from the other offers 34, using high quality materials.

The coupon package is not strictly limited to coupon or certificate based offers. Promotional materials, samples, premiums, rebates or other items may be provided by the offering companies 12 that can be included in the offer package. The travel coupon server 20 may be directed to provide these items to all travelers 10 to a destination or to only those travelers 10 that match the offering company's target traveler profile criteria. Alternatively, the coupon package may be routed to special printers and handling processes when the offering company 12 specifies that type of handling. The preparation of the actual coupon may be handed off to another company where the content of the coupon or certificate is provided by the travel coupon server 20 either alone or in coordination with the offering company 12. The travel coupon server 20 may additionally allow the offering company 12 to prepare the package for the traveler 10 where all or a portion of the information stored in the travel coupon server 20 related to a traveler 10 is transmitted or relayed to the offering company 12 when direct contact is authorized.

The actual form of the coupon generated may be supplied by the offering company 12 or made by the travel coupon server 20 in response to offering company parameters or generated by a third party of another form. Electronic coupons may also be generated by this server 20 where the user does not receive the coupon but a notification message is generated by the travel coupon server 20 and is transmitted to the offering company 12 that an offer has been made to the traveler 10. The traveler 10 would then receive a report or list of the offering companies 12 that provided offers. Accordingly, the offering company 12 is aware of the parameters of the offer and is required to honor the offer at the traveler's redemption of the discount coupon.

Coupons may alternatively be submitted in an email package where the email contains the coupons in a printable form, or where the email contains a link to a computing resource that holds a specially prepared package for that traveler 10. The traveler 10 would be provided an access code or link that directs the user to the appropriate destination where the user may review and accept the coupon.

Other forms of coupons may also be generated not specifically limited to a paper coupon or certificate. An airline ticket jacket may be delivered to the traveler 10 where the jacket contains the coupons printed on the jacket. A passport folder may be provided with the folder made of coupons. Other materials and shapes may be provided such as a cloth, plastic, vinyl, or leather formed into a traveling bag emblazoned with the printed-on limited time duration coupons. The bag becomes a reminder of the trip and a convenient place to store items purchased at the locations printed on the bag. This personalized bag contains the name of the traveler 10 along with the dates when the trip occurred to that travel destination. The coupons may be printed on the inside or outside surface of the bag. Instead of the name being reproduced on all of the individual coupons in this case, the name would appear once in some protected area of the bag.

If the traveler 10 is working with an intermediary agent, such as a travel agent 24 or an airline 28 to arrange travel, the intermediary agent may be able to access the offer data 34 in real-time related to a traveler's route and destination or plurality of destinations. Since travel agents 24 provide services for the traveler 10 beyond those typically offered by an airline reservation's agent, the travel agent 24 may investigate the available offers 34 on the server 20 to determine how a travel plan may be best modified to take advantage of the offers 34 provided by the server 20.

Intermediary agents may provide their services to obtain such discount coupons and offers to be only available to select groups, such as a club including country clubs, unions, professional associations, credit card associations, religious organizations, financial institutions, and educational institutions, frequent flyer programs, insurance companies, etc. Other select groups may include discounts applicable to specific passenger classes of airlines, such as business offers being targeted and only available to business-class air travelers. Thus, the intermediary agents, using the disclosed system, can provide different levels of access to discounts and services.

The intermediary agents may also include travel facilitators in corporations and/or government agencies, who specialize in arranging itineraries as well as locking in discounts or other deals for improved services and amenities for users.

Facilitating tools such as scheduling tools may be provided by the travel coupon server 20 that the travel agent 24 or traveler 10 can access to schedule a detailed itinerary of daily events for the traveler 10. The data generated by the travel agent 24 on the travel coupon server 20 may be printed into a coupon package that the traveler 10 may take with them to review at their leisure. The travel agent 24 may additionally perform other searches or generate requests for events to be established which may then be distributed to participating offering companies 12. Responses made to the travel agent 24 may then be coordinated through the travel coupon server 20 to update a coupon package for the traveler 10 that may be printed at a later time.

Airlines 28 may provide the traveler 10 with added value by using this travel coupon server 20 to provide coupons or certificates valid during the time of travel to the named traveler 10 to facilitate the arrival, departure, transfers and hotel, meal, and entertainment reservations processes typically involved in travel. For example, first class travelers may be provided with coupons/certificates that may enable them to access special events or expedited service where the offering companies 12 may arrange to fulfill redemption-based detailed requests matching the traveler's itinerary while at that destination.

Offering companies 12 may be small local companies located at one travel destination or may comprise multi-national companies having company locations all over the world. A multi-national company such as a hotel chain may want to provide coupons to all travelers 10 that arrive at an airport within 20 miles, or any reasonable distance, of their facility. These coupons would be prepared and inserted into the package whenever a traveler 10 selects that travel destination whether the traveler 10 selects that hotel or other hotels during this travel period.

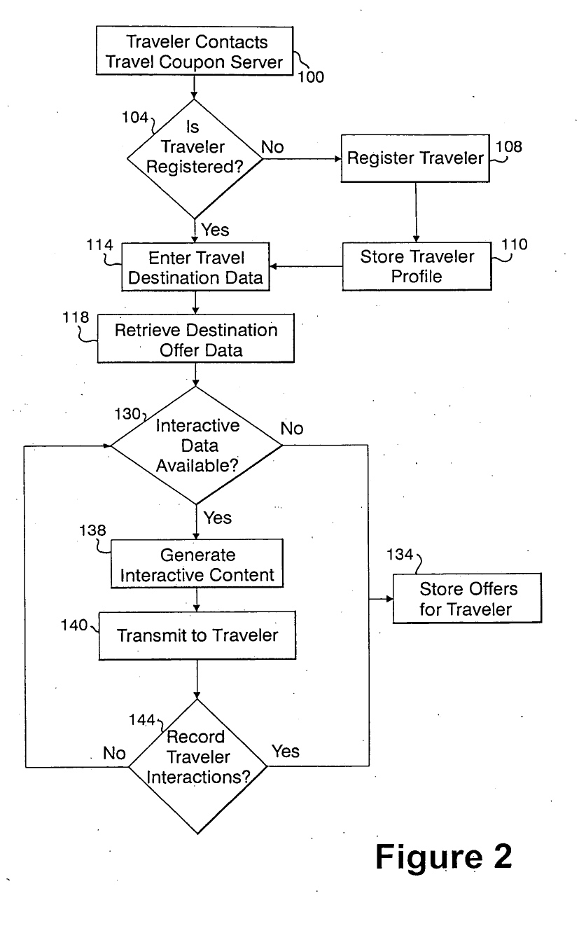

The preferred embodiment of the computer integrated system described in FIG. 1 for arranging for travel coupons through the travel coupon server 20 will now be described with regard to FIG. 2. The traveler 10 may access the travel coupon server 20 at step 100 directly via known computer access mechanisms, such as an Internet connection from an Internet-accessible traveler's computer where, upon entering and verifying registration information at step 104, the user may then be directed to an interface form where the user may select and enter data to describe the details of the travel at step 114. The system may also be implemented with wireless, satellite, and cable applications, including WebTV applications. Thus, the system may be utilized by both travelers and non-travelers to provide discount coupons for use in geographically-specific areas.

A web enabled interface or graphic or audio or voice interactive interface may be provided that is accessible via any type of computing device over any type of communications means to contact the travel coupon server 20. If the traveler 10 is a new user to the system, the traveler 10 registers at step 108 where the traveler 10 enters their leisure and business related interests in a traveler profile. The system then stores the registered traveler's profile in the database of user/traveler profiles 32 in step 110. The method then proceeds to step 114.

In another embodiment the traveler 10 may be represented by an agent such as a travel agent 24 where the name is unknown to the travel coupon server 20 but a reference is maintained to the actual traveler identity. The actual traveler identity would only be required at the point of coupon generation where the name is used in real-time to generate the coupons and the agent's identifier or name is also indicated on the coupon. In this manner the traveler name is never recorded in the database of user profiles 32. For example, famous personalities or travelers wishing to remain anonymous would not be required to have their personal information recorded on the system other than that needed to take advantage of the offers 34 provided by this system. For example, such users may employ pseudonyms or aliases.

In addition, both users and offering companies benefit, since discounted services and other features such as anonymity provide users with immediate enticements, and thus promote and drive traffic to such services. Such services and features may also be provided to travelers in cyberspace as one navigates to order or otherwise obtain electronic goods and electronic services including downloaded music for immediate use. Such cyberspace navigation may also be made anonymous using the disclosed system. Accordingly, the disclosed system is not limited to actual physical travel.

Following registration, the travel coupon server 20 retrieves from memory at step 118 all offer data 34 that corresponds to the traveler's selected travel destination and route that has an effective period corresponding to the traveler's timeframe for travel. If at step 130, data is available corresponding to the traveler's selected destination or route, any offer data or interactive data that may exist in the server 20 may be generated at step 138 to be presented to the user via the user interface. Otherwise, in step 130, if no interactive data is available, the method proceeds to step 134 to store offers for the particular traveler without interactive data.

If interactive data is available after step 138, the travel coupon server 20 may generate a plurality of interactive content that may be transmitted to the user/traveler 10 at step 140. The traveler 10 may review this content or request further content. Any user interactions are preferably recorded at step 144, for example, if the traveler 10 chooses to record the traveler interactions without further information about interactive data, the method proceeds to step 134. Otherwise, in response to the traveler 10 not choosing to record the traveler interactions at that time, the method returns to step 130 to retrieve additional interactive data to present to the traveler 10 and to be stored with the offers for the traveler in step 134. The user interactions may be analyzed by the travel coupon server 20 at a later time. Other content may be prepared in response to the traveler generated requests. The offers matching or correlated to any of the retrieved or requested content are stored for the traveler 10 at step 134.

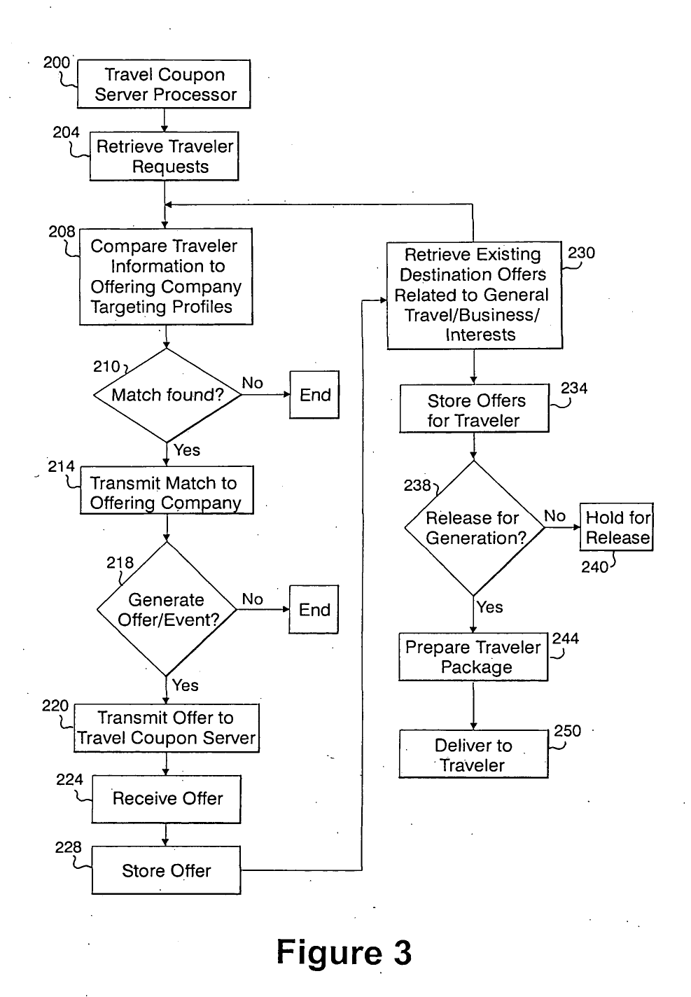

The travel coupon server 20 functions will be described with regard to FIG. 3, in which, in the travel coupon server 20, the processor and/or processing means, which may be implemented in hardware and/or software, operates in step 200 to perform the functions described herein, including steps 204-250. After the travel coupon server 20 receives requests from a traveler 10 in step 204, the method performs steps 208-250, with steps 230-250 being performed concurrently with steps 208-228 to process multiple traveler requests.

Referring to the right side of FIG. 3 including, steps 230-250, in response to system generated events or in response to offering company initiated events, the travel coupon server 20 may initiate the generation of coupon or offer content for the traveler 10 in response to a traveler request. In one embodiment, the travel coupon server 20 may generate an initial package for the traveler 10 at the time of the aforementioned interactive session that is delivered to the traveler 10 immediately. In another embodiment, the system may interrogate the database to retrieve travel records at step 204 that have been input by the traveler 10 where the travel is to begin within a specified timeframe. A release schedule may be used in the system to iteratively interrogate the system for different types of events based on a user or system specified schedule of notification.

The server 20 accesses the offers 34 at step 230 which may comprise interactively generated offers or offers that are generated in an offline mode without traveler interaction. The travel coupon server 20 may query the database of offers 34 for other offers that may have been generated since the original interactive request. These offers 34 are stored in the database where the user identifier is associated with the offer. Throughout the time prior to actual coupon generation, more offers may be compiled and stored by the server 20 at steps 230 and 234, respectively.

If the coupons are available for release by the server 20 at step 238, the coupon package is prepared at step 244; otherwise, due to unavailability of the coupons, for example, if limited number of available discount coupons runs out, such as due to excessive demand, the release is put on hold or a request is made in step 240. Step 244 incorporates the name of the traveler 10 into the coupon. The date of expiration corresponds to the end of travel or may be extended to expire a short time after the end of the theoretically planned departure date. For example, travelers planning to travel on business or leisure requests that business activities be coordinated into their schedule. The business activities that match the traveler's profile 32 may be generated one month prior to travel to allow the traveler 10 to prepare for the event if the traveler 10 has been given adequate notice of the travel. The system may generate these coupons at step 238 and send them, after preparation in step 244, for delivery to the user/traveler 10 in step 250. Two weeks prior to departure the system may again interrogate the database to identify leisure or business activities that meet the traveler's profile 32.

Alternatively, the generated coupon and its package may be booked by the traveler to be delivered to a particular establishment, such as a hotel on the traveler's itinerary, for pick-up when the traveler arrives. Such booking of the delivery of coupons may also be applied to local or domestic travelers; for example, for a clothing shop a short distance from the customer's home, the customer may book delivery to that clothing shop to redeem any available discount coupons.

The user/traveler 10 may modify the itinerary for travel at any time prior to, or during the travel where the system may adjust the search performed to return offers matching the revised itinerary. The timeframes specified above are exemplary and may be modified to reflect any dates or time periods for prior notification. Similarly, coupons provided for non-travelers may be time specific or date specific for the use/redemption of the coupons by non-travelers.

The delivery of the coupon package in step 250 would be coordinated according to the departure and travel locations specified during travel. Since the interface is accessible in a world-wide manner, the traveler 10 may query the server 20 in real-time to find the most recent offers at their current location and have the coupon package directed to their current, or to a future destination where it may be held for them.

In an alternative embodiment, steps 238-250 may operate to output a coupon directly to the traveler 10 at the printer of the traveler 10, for example, in Internet/E-commerce applications of the travel coupon server system. For example, after offers 34 are stored in the offer database in step 234, the method allows travelers to access and view available offers 34, such as by inputting destination or flight numbers as described herein. The method then responds to a release command in step 238 input from a traveler 10 to select a specific offer when the specific offer is displayed on the web browser of the traveler 10. Otherwise, in step 240, if no selection of a displayed offer is received, the release of the coupon to the traveler is held.

In this E-commerce embodiment, the travel coupon server 20 then prepares a traveler package in step 244 by generating coupon data in a coupon format for printing by the traveler's printer, as described herein, and the coupon is then delivered to the traveler 10 directly in step 250 by the direct printing of the coupon using the formatted coupon data at the traveler's printer. In an alternative embodiment, steps 244-250 may be performed by E-mail, such that the coupon may be an attachment to the E-mail which may be displayed by an E-mail application as a bitmap or other graphic format, or alternatively in a word processing or presentation document for printed by a word processor or presentation software, respectively. Accordingly, the delivery is not delayed by third parties such as postal mail, and the coupon is provided locally to the traveler 10 at the traveler's own computer, which may including portable computing devices such as the PalmPilot or the Handspring Visor.

With regard to the left portion of the flow diagram of FIG. 3 including steps 208-228, an offering company 12 may interrogate the server 20 periodically or may be notified by the travel coupon server 20 at step 208 when a request is received by the travel coupon server 20 that references a traveler 10 matching the offering company specified target traveler profile at step 210. If the user specifies in the rules database 38 that specific rules must be adhered to for the user to accept an offer, the rules 38 are retrieved from the database to assure that any new event generated by an offering company 12 must match those rules 38. If no match is found, the method ends the processing of the current traveler information.

Otherwise, after step 210, the matching entries or requests are transmitted to the offering company 12 at step 214, where the offering company 12 may generate a new event matching the request transmitted at step 218. The offering company 12, with its own plans and criteria, may choose whether or not to provide an offer to the matching travelers 10. For example, if there is not enough interest in an offer or not enough travelers 10 to be profitable to the offering company 12, the offering company 12 may not generate the offer in step 218 and end the processing of the matches. However, if an offer is generated in step 218, the offering company 12 transmits the offer in step 220 to the travel coupon server 20 where the offer is received in step 224, and is recorded in step 228 in the database of offers 34. The method then proceeds to step 230.

If the offering company 12 connects directly to the travel coupon server 20, the offer may be made at the server 20 directly through a provided coupon generation interface. The offering company 12 may alternatively review user profiles 32 presented in an on-line manner to generate offers dynamically. This new offer is then available to the travel coupon server 20 for generation and disbursement. The output coupon may be generated as soon as the system receives the offer or may be directed to a destination printing address for subsequent delivery or pickup by the traveler 10. The coupon need not be generated or issued immediately after the offer is provided to the coupon generation interface. For example, only a notice of issuance of the coupon is necessary to be sent to the offering company, such that upon receipt of an offer at the coupon generation interface, no offer may be refused, regardless of when the actual coupon is generated and distributed.

As previously described, the coupons may include bar codes or other indicia such as serial numbers or locator numbers, and coupons may be generated sequentially with consecutive numbers, or encoded consecutive numbers in, for example, a bar code. The generated coupons are not generic, but instead are trackable, for example, to determine their use and their effectiveness in a marketing campaign using such coupons.

In one embodiment, the a portion of the rules retrieved from the database of rules 38 and stored in the travel coupon server 20 may be related to tax rules for proper deductible expenses.

The events generated may be developed by one company or may be a cooperative effort of several companies that may coordinate their activities through this system to provide a conference-like event. For example, business travelers 10 that wish to coordinate leisure and business into one trip to a destination may submit a request for an event related to a certain field of technology. A hotel, restaurant, airline 28, and travel agent 24, in addition to or themselves being offering companies 12, may be able to identify a number of travelers 10 wishing to travel to a particular destination or geographic region during a particular timeframe, and then may coordinate an event that may be a deductible expense. These previously unrelated travelers 10 may be notified of this generated event matching their criteria which may then cause the travelers 10 to select that event and location mutually arranged between those offering companies 12 for inclusion into the traveler's itineraries. One or several cooperatively generated event coupons would be generated by the system for distribution to those travelers 10.

A billing process is incorporated into the travel coupon server 20 where, as coupons are generated, the offering company 12 is charged a fee for the inclusion into the coupon package, and/or a fee is charged for each issued coupon. Such fees may also include payment-for-service charges, taxes, and insurance premiums and fees. The names of the travelers 10 may be recorded in a transaction record, indicating the nature of the offer and the date of issuance, along with the travel period. This type of information may be of significant value to the offering companies 12 to verify billing and to generate potential customer lists. The billing and transaction information may also be updated by the offering company 12 to track the number of offers that were redeemed. This would require the offering company 12 to contact the travel coupon server 20 to indicate the redemption. The list of travelers 10 may also be of value to the offering companies 12 prior to the traveler 10 reaching the travel destination such that confirmation or events may be closely coordinated. Billing may be performed electronically between the offering companies 12 and the travel coupon server 20 of this invention. In the preferred embodiment travelers 10 are not charged a fee to use this system. In another embodiment, travelers 10 may be charged a fee for the use of this system where, for example, they pay a yearly fee to join, or where the fee is based on the services selected, or where the fee is based on the amount of travel that a given traveler 10 does a year. Advertisers may also pay fees to be listed on the travel coupon server 20 where they may provide coupons or may simply provide links to other locations.

The server 20 of this invention may be run independently or may be embedded into an existing infrastructure to provide added value and services within an industry. Airlines 28, for example, may offer the functionality of this system as an additional incentive to join a frequent flyer program or to enhance the overall effectiveness of services offered by the frequent flyer program. Preferred business partners may join into mutually beneficial arrangements with the air carrier to increase commerce for both participants.

A hotel and airfare package during prime or off-season may be easily coordinated through the use of this system. The coupons generated would in this example accompany the airline ticket or precede the ticket delivery or pickup. Alternatively, the coupons would may be available at a website visited by the traveler at any location on the traveler's itinerary, or even upon arrival at any location where the coupon is redeemable.

1-40 (Canceled).

41. A coupon generation and distribution system comprising:
(a) a plurality of member computers interconnected to a computer network, each of said member computers associated with at least one of a plurality of members of the system; and
(b) a centrally located coupon server computer, interconnected to the computer network for selective communication with the plurality of member computers, the coupon server computer comprising:
(i) a repository of coupon offers available for generation into coupons for dissemination to a plurality of users, each of said coupon offers supplied to the coupon server computer by a coupon offering entity and providing an incentive to purchase an item;
(ii) means for storing a plurality of user profile data records, each of said user profile data records comprising user profile data comprising:
an identification of a user, and
at least one geographic location associated with the user;
(iii) means for analyzing a user profile data record with respect to a plurality of coupon offers in the repository and for analyzing a, coupon offer with respect to a plurality of user-profile data records, and for generating one or more coupons based on said analysis, wherein said coupon is limited to use by the user identified in the user profile data record for items at the geographic location associated with the user; and
(iv) means for distributing said generated coupon for use by the user in purchasing the item associated with the coupon at the geographic location associated with the user.

42. The system of claim 41 wherein the user profile data is obtained from at least one member computer.

43. The system of claim 41 wherein the computer network is the Internet.

44. The system of claim 41 wherein the computer network is a wireless network.

45. The system of claim 41 wherein a member computer is an interactive television device.

46. The system of claim 41 wherein a member computer is a voice interactive device.

47. The system of claim 41 wherein a member computer is an Internet-enabled computing device.

48. The system of claim 41 wherein a member computer is a portable computing device.

49. The system of claim 41 wherein the means for distributing said generated coupon comprises means for transmitting said coupon to the user.

50. The system of claim 49 wherein the means for transmitting said coupon to the user comprises means for electronically transmitting said coupon to a member computer.

51. The system of claim 50 wherein the means for electronically transmitting said coupon to a member computer comprises means for sending an email message to a member computer, said email message comprising said coupon in a format suitable for printing at a printer associated with the member computer.

52. The system of claim 41 wherein the means for distributing said generated coupon comprises means for transmitting said coupon to a member computer associated with a merchant that will honor the generated coupon.

53. The system of claim 52 wherein the user specified by the coupon is provided with the incentive specified by the coupon during a transaction with the merchant.

54. The system of claim 41 wherein the means for distributing the generated coupon comprises means for printing the coupon and sending said printed coupon to the user.

55. The system of claim 41 wherein the user profile data further comprises demographic information relating to the user.

56. The system of claim 41 wherein the user profile data further comprises coupon requests provided by a user to the coupon server computer, and wherein the coupon requests are transmitted by the coupon server computer to a coupon offering entity for use in preparing subsequent coupon offers.

57. The system of claim 41 wherein the user profile data further comprises flight information regarding an airline flight to be taken by a user, and wherein said flight information is utilized by the coupon server computer to generate the coupon.

58. The system of claim 41 wherein the user profile data further comprises travel itinerary information of a user and wherein said travel itinerary information is utilized by the coupon server computer to generate the coupon.

59. The system of claim 41 wherein the coupon offers vary in accordance with the geographic location associated with the user.

60. The system of claim 41 wherein the coupon offers comprise offer terms which are variable.

61. The system of claim 60 wherein the offer terms vary in accordance with the frequency of redemption of said offers.

62. The system of claim 41 wherein a member computer further comprises display means for displaying coupon data to the user, and wherein images of the coupons generated by the coupon server are transmitted to the member computer and displayed to a user via the display means.

63. The system of claim 62 wherein the user inputs, via the member computer input means, selections of said displayed coupon images, and wherein said coupon server generates a subset of said plurality of coupons based on the coupon image selections made by the member.

64. The system of claim 41 wherein the members are selected from the group consisting of a coupon offering company, a user, a travel agent, an airline, and a cruise line.

65. The system of claim 41 wherein the coupon offering entity specifies user match parameters to the coupon server for use in generating coupons from the user profile and coupon offers.

66. The system of claim 41 wherein the coupon offers are modified by the coupon offering entity prior to generation of coupons by the coupon server.

67. The system of claim 41 wherein the user profile further comprises information on a mode of travel by the user to the associated geographic location, and wherein the coupons generated by the coupon server relate to the mode of travel by the user.

68. The system of claim 41 wherein the user profile further comprises information on dates of travel by the user to the associated geographic location, and wherein the coupons generated by the coupon server are valid only during the dates of travel by the user.

69. A method for generating and distributing coupons comprising the steps of:
(a) a plurality of coupon offering entities supplying coupon offers to a centrally located coupon server computer, said coupon offers each and providing an incentive to purchase an item;
(b) the coupon server computer assembling a repository of said coupon offers for subsequent generation into coupons for dissemination to a plurality of users;
(c) the coupon server computer storing a plurality of user profile data records, each of said user profile data records comprising user profile data comprising:
an identification of a user, and
at least one an geographic location associated with the user;
(d) analyzing a user profile data record with respect to a plurality of coupon offers in the repository and analyzing a coupon offer with respect to a plurality of user profile data records;
(e) generating one or more coupons based on said analysis, wherein said coupon is limited to use by the user identified in the user profile data record for items at the geographic location associated with the user; and
(f) distributing said generated coupon for use by the user in purchasing the item associated with the coupon at the geographic location associated with the user.

70. The method of claim 69 wherein the user profile data is obtained from at least one member computer.

71. The method of claim 69 wherein the computer network is the Internet.

72. The method of claim 69 wherein the computer network is a wireless network.

73. The method of claim 69 wherein a member computer is an interactive television device.

74. The method of claim 69 wherein a member computer is a voice interactive device.

75. The method of claim 69 wherein a member computer is an Internet-enabled computing device.

76. The method of claim 69 wherein a member computer is a portable computing device.

77. The method of claim 69 wherein the step of distributing said generated coupon comprises the step of transmitting said coupon to the user.

78. The method of claim 77 wherein the step of transmitting said coupon to the user comprises the step of electronically transmitting said coupon to a member computer.

79. The method of claim 78 wherein the step of electronically transmitting said coupon to a member computer comprises the step of sending an email message to a member computer, said email message comprising said coupon in a format suitable for printing at a printer associated with the member computer.

80. The method of claim 69 wherein the step of distributing said generated coupon comprises the step of transmitting said coupon to a member computer associated with a merchant that will honor the generated coupon.

81. The method of claim 80 wherein the user specified by the coupon is provided with the incentive specified by the coupon during a transaction with the merchant.

82. The method of claim 69 wherein the step of distributing the generated coupon comprises the steps of printing the coupon and sending said printed coupon to the user.

83. The method of claim 69 wherein the user profile data further comprises demographic information relating to the user.

84. The method of claim 69 wherein the user profile data further comprises coupon requests provided by a user to the coupon server computer, and wherein the coupon requests are transmitted by the coupon server computer to a coupon offering entity for use in preparing subsequent coupon offers.

85. The method of claim 69 wherein the user profile data further comprises flight information regarding an airline flight to be taken by a user, and wherein said flight information is utilized by the coupon server computer to generate the coupon.

86. The method of claim 69 wherein the user profile data further comprises travel itinerary information of a user and wherein said travel itinerary information is utilized by the coupon server computer to generate the coupon.

87. The method of claim 69 wherein the coupon offers vary in accordance with the geographic location associated with the user.

88. The method of claim 69 wherein the coupon offers comprise offer terms which are variable.

89. The method of claim 88 wherein the coupon offers vary in accordance with the frequency of redemption of said offers.

90. The method of claim 69 wherein images of the coupons generated by the coupon server are transmitted to the member computer and displayed to a user.

91. The method of claim 74 wherein the user inputs selections of said displayed coupon images, and wherein said coupon server generates a subset of said plurality of coupons based on the coupon image selections made by the member.

92. The method of claim 69 wherein the members are selected from the group consisting of a coupon offering company, a user, a travel agent, an airline, and a cruise line.

93. The method of claim 69 wherein the coupon offering entity specifies user match parameters to the coupon server for use in generating coupons from the user profile and coupon offers.

94. The method of claim 69 wherein the coupon offers are modified by the coupon offering entity prior to generation of coupons by the coupon server.

95. The method of claim 69 wherein the user profile further comprises information on a mode of travel by the user to the associated geographic location, and wherein the coupons generated by the coupon server relate to the mode of travel by the user.

96. The method of claim 69 wherein the user profile further comprises information on dates of travel by the user to the associated geographic location, and wherein the coupons generated by the coupon server are valid only during the dates of travel by the user.
